(19) United States
(12) Patent Application Publication
(10) Pub. No.: US 2003/0076227 A1
(43) Pub. Date: Apr. 24, 2003

(54) Lighting safety indication device of snorkel

(76) Inventor: Tzong-Fuh Kuo, Hsin Juang City (TW)

Correspondence Address: Keith Kline, PRO-TECHTOR INTERNATIONAL SERVICES, 20775 Norada Court, Saratoga, CA, 95070-3018, US

(21) Appl. No.: 10/015,173

(22) Filed: Oct. 22, 2001

(51) Int. Cl. G08B 21/00

(52) U.S. Cl. 340/540

(57) ABSTRACT

The present invention relates to a lighting safety indication device of a snorkel. A transparent light shade is mounted on the top end of the body of the snorkel, and is provided with a light source for emitting light outward from the top end of the body of the snorkel. Thus, when the sun light disappears on a cloudy day or at the night, the top end of the body of the snorkel may light or blink to clearly and apparently indicate the present location of the diver, thereby preventing the diver from being hit or struck unintentionally by the boat or ship, so as to protect the diver's safety.

### BACKGROUND OF THE INVENTION

1. Field of the Invention

The present invention relates to a lighting safety indication device of a snorkel, and more particularly to a lighting safety indication device of a snorkel, wherein when the sun light disappears on a cloudy day, the snorkel may light or blink to clearly and apparently indicate the present location of the diver, thereby preventing the diver from being hit or struck unintentionally by the boat or the ship, so as to protect the diver's safety.

2. Description of the Related Art

A conventional snorkel 100 of a diving equipment in accordance with the prior art is shown in FIG. 1. When a diver is floating on the sea level, the snorkel 100 may be bonded with a reflective bonding paper 200 on the top end thereof, for indicating the position of the diver by the reflective effect of the reflective bonding paper 200 on the top end of the snorkel 100, thereby preventing the diver from being hit or struck unintentionally by the boat, ship, beach motorcycle or the like, so as to protect the diver's safety.

However, when the sun light disappears on a cloudy day or at the night, the reflective bonding paper 200 on the top end of the snorkel 100 will fail and lose its effectiveness, thereby easily causing an accidence during the diving process.

### SUMMARY OF THE INVENTION

The present invention has arisen to mitigate and/or obviate the disadvantage of the conventional snorkel.

The primary objective of the present invention is to provide a lighting safety indication device of a snorkel, wherein the top end of the body of the snorkel is provided with a light emitting device, so that when a diver is floating on the sea level, the top end of the body of the snorkel may light or blink. Thus, when the sun light disappears on a cloudy day or at the night, the top end of the body of the snorkel may light or blink to clearly and apparently indicate the present location of the diver, thereby preventing the diver from being hit or struck unintentionally by the boat, the ship, the beach motorcycle or the like, so as to protect the diver's safety.

In accordance with the present invention, there is provided a lighting safety indication device of a snorkel, the snorkel having a body whose top end is formed with a vent hole and is provided with a reflective bonding paper, the improvement comprising: a transparent light shade is mounted on the top end of the body of the snorkel, and is provided with a light source for emitting light outward from the top end of the body of the snorkel.

The top end of the body of the snorkel is formed with an outer thread, and the light shade has a bottom end having an inner wall formed with an inner thread screwed on the outer thread of the body of the snorkel.

The lighting safety indication device of a snorkel further comprises a watertight washer mounted between the outer thread of the body of the snorkel and the inner thread of the light shade.

The light source in the light shade includes an electric bulb, a battery, and a conductive plate.

The light source in the light shade includes at least one LED, IC, battery and conductive plate.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional snorkel in accordance with the prior art;

FIG. 2 is a perspective view of a lighting safety indication device of a snorkel in accordance with a preferred embodiment of the present invention;

FIG. 3 is an exploded perspective view of a lighting safety indication device of a snorkel in accordance with a preferred embodiment of the present invention; and

FIG. 4 is a cross-sectional view of the lighting safety indication device of a snorkel as shown in FIG. 2.

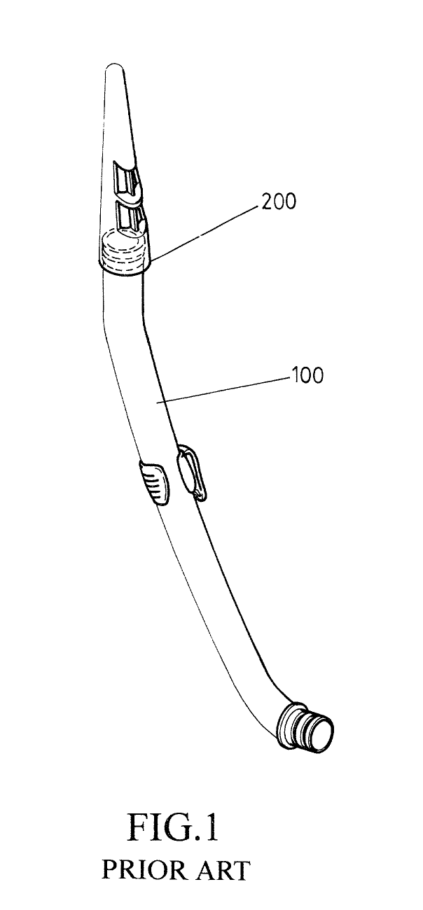

### DETAILED DESCRIPTION OF THE INVENTION

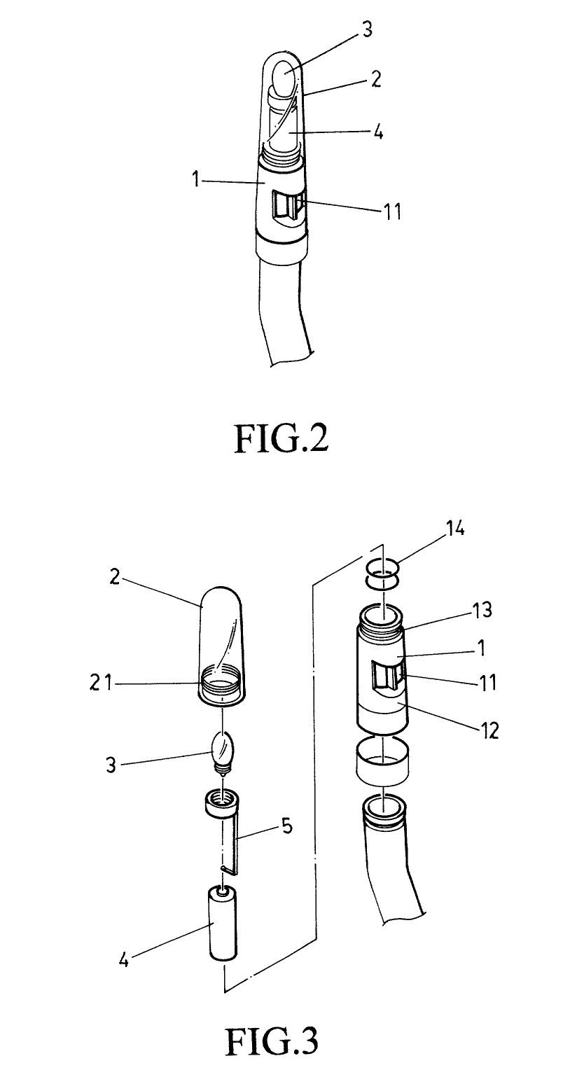

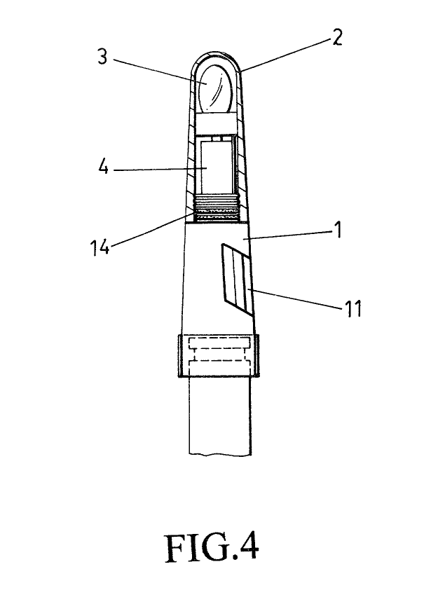

Referring to FIGS. 2-4, a lighting safety indication device of a snorkel in accordance with a preferred embodiment of the present invention is shown. The snorkel has a body 1 whose top end is formed with a vent hole 11 and provided with a reflective bonding paper 12.

The body 1 of the snorkel has a top end formed with an outer thread 13, and a watertight washer 14 is mounted on the outer thread 13. A light shade 2 is mounted on the top end of the body 1 of the snorkel, and has a bottom end having an inner wall formed with an inner thread 21 that is screwed on the outer thread 13 of the body 1 of the snorkel. The light shade 2 is a transparent housing having an opened side. The light shade 2 is waterproof by mounting of the watertight washer 14. An electric bulb 3 or an LED is mounted in the light shade 2. The bottom end of the electric bulb 3 may be provided with a battery 4 which contacts a conductive plate 5 on the bottom end of the electric bulb 3, so that the electric bulb 3 may light.

In addition, the electric bulb 3 may be replaced by at least one LED mating with an IC device, so that the at least one LED may blink.

In conclusion, in accordance with the lighting safety indication device of a snorkel of a preferred embodiment of the present invention, the top end of the body 1 of the snorkel is provided with a light emitting device, so that when a diver is floating on the sea level, the top end of the body 1 of the snorkel may light or blink. Thus, when the sun light disappears on a cloudy day or at the night, the top end of the body 1 of the snorkel may light or blink to clearly and apparently indicate the present location of the diver, thereby preventing the diver from being hit or struck unintentionally by the boat, ship, beach motorcycle or the like, so as to protect the diver's safety.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A lighting safety indication device of a snorkel, the snorkel having a body whose top end is formed with a vent hole and is provided with a reflective bonding paper, the improvement comprising:
a transparent light shade is mounted on the top end of the body of the snorkel, and is provided with a light source for emitting light outward from the top end of the body of the snorkel.

2. The lighting safety indication device of a snorkel in accordance with claim 1, wherein the top end of the body of the snorkel is formed with an outer thread, and the light shade has a bottom end having an inner wall formed with an inner thread screwed on the outer thread of the body of the snorkel.

3. The lighting safety indication device of a snorkel in accordance with claim 1, further comprising a watertight washer mounted between the outer thread of the body of the snorkel and the inner thread of the light shade.

4. The lighting safety indication device of a snorkel in accordance with claim 1, wherein the light source in the light shade includes an electric bulb, a battery, and a conductive plate.

5. The lighting safety indication device of a snorkel in accordance with claim 1, wherein the light source in the light shade includes at least one LED, IC, battery and conductive plate.
